(19) United States
(12) Patent Application Publication
(10) Pub. No.: US 2012/0026284 A1
(43) Pub. Date: Feb. 2, 2012

(54) IMAGING APPARATUS AND CONTROL METHOD THEREFOR

(75) Inventors: Kazuhiro Watanabe, Tokyo (JP); Wataru Kaku, Yokohama-shi (JP); Osamu Sakata, Yokohama-shi (JP); Daijirou Nagasaki, Kamakura-shi (JP); Kaoru Konishi, Tokyo (JP); Satoshi Shinata, Tokyo (JP)

(73) Assignee: CANON KABUSHIKI KAISHA, Tokyo (JP)

(21) Appl. No.: 13/194,715

(22) Filed: Jul. 29, 2011

(30) Foreign Application Priority Data
Aug. 2, 2010 (JP) 2010-173625

(51) Int. Cl. H04N 7/00

(52) U.S. Cl. 348/36; 348/E07.001

(57) ABSTRACT

The present invention relates to an imaging apparatus capable of shifting to a panoramic shooting function based on a user's intention without performing a complicated setting operation. In a digital camera, when a zoom operation member is operated again to a wide-angle side within a predetermined length of time after the zoom operation member has been operated to the wide-angle end, the process shifts to the panoramic shooting mode.

### BACKGROUND OF THE INVENTION

1. Field of the Invention

The present invention relates to an imaging apparatus having a panoramic shooting function and a control method therefor.

2. Description of the Related Art

Conventional imaging apparatuses are known to have a panoramic shooting function for shooting a plurality of photographs while linking them together and for combining them into one image, when shooting a landscape or the like which extends far beyond a widest angle of view is performed. Japanese Patent Application Laid-Open No. 2005-223905 discusses a camera that facilitates a panoramic shooting.

Japanese Patent Application Laid-Open No. 6-94970 discusses a camera that performs shooting by selecting a normal shooting mode or a panoramic shooting mode so that a margin other than a main object becomes less based on the proportion of the main object in an angle of view.

Japanese Patent Application Laid-Open No. 2006-191289 discusses a camera that performs shooting by switching to the panoramic shooting mode in a case where a communication terminal that transmits positional information to the camera cannot perform framing from the positional information of the communication terminal.

However, in the above-described conventional imaging apparatuses, the panoramic shooting function is set as a special function, and a shooting operation becomes complicated because a user has to call the function from a menu or the like by repeating button operations.

Japanese Patent Application Laid-Open No. 6-94970 discusses a camera having a function for switching the mode to the panoramic shooting mode upon determination that panoramic shooting is suitable based on information of a detected object. However, since the shooting mode is selected so that a margin other than the main object becomes less based on the proportion of the main object in an angle of view, shooting cannot be performed in some cases, such as with buildings being included.

Japanese Patent Application Laid-Open No. 2006-191289 discusses a technique for shifting to the panoramic shooting mode when a communication terminal that transmits positional information extends far beyond an angle of view. However, it is difficult to reflect user' s intentions, such as how far an object accounts for a proportion of the angle of view in a photograph, or what landscape is included in a background.

### SUMMARY OF THE INVENTION

The present invention relates to an imaging apparatus capable of shifting to a panoramic shooting function based on a user's choice without performing a complicated setting operation and a control method therefor, a program, and a recording medium.

According to an aspect of the present invention, an imaging apparatus includes an imaging unit, a zoom operation member, a driving unit configured to drive a zoom lens according to an operation to the zoom operation member, and a processing unit configured to execute control to perform processing for shifting to a panoramic shooting mode for shooting a plurality of images to be combined as a panoramic image, if the zoom lens is positioned at a wide-angle end and the zoom operation member is further operated to zoom to a wide-angle side.

According to the present invention, it becomes possible to shift to the panoramic shooting function based on the user's choice without performing a complicated setting operation.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIGS. 1A and 1B illustrate an outline view of a digital camera as an example of an imaging apparatus according to a first exemplary embodiment of the present invention.

FIG. 2 is a block diagram illustrating an example of an internal configuration of the digital camera in FIG. 1.

FIG. 3 illustrates the widest angle of view (shooting range) of the digital camera in FIG. 1 that can be captured by one shooting operation.

FIG. 4 is a flowchart illustrating a flow of a panoramic shooting mode shifting process in the first exemplary embodiment.

FIG. 5 is a flowchart illustrating a flow of a panoramic shooting mode shifting process in a second exemplary embodiment.

### DESCRIPTION OF THE EMBODIMENTS

Various exemplary embodiments, features, and aspects of the invention will be described in detail below with reference to the drawings.

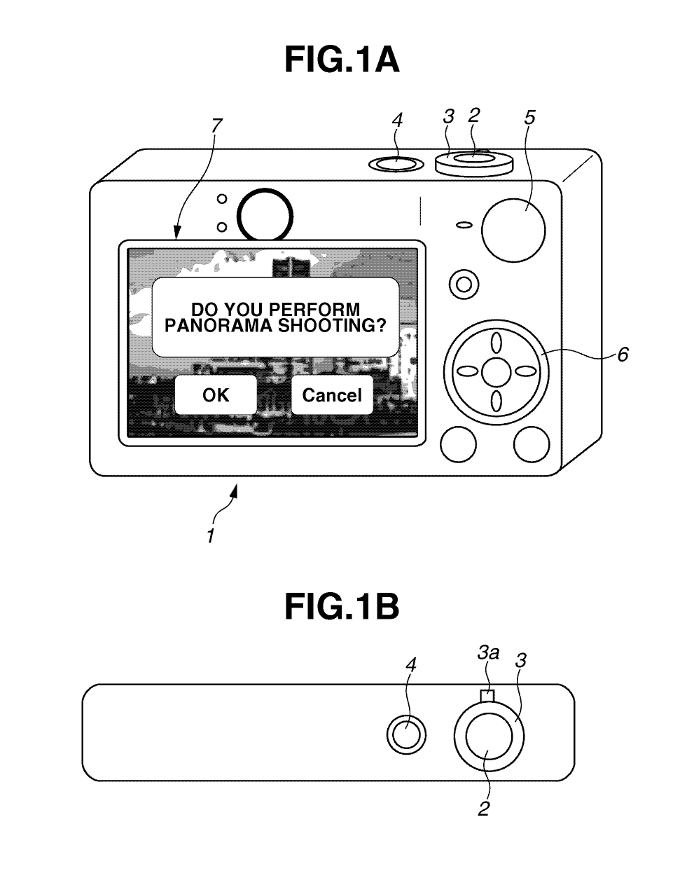

FIGS. 1A and 1B illustrate an outline view of a digital camera as an example of an imaging apparatus according to a first exemplary embodiment of the present invention. FIG. 1A is a side view as viewed from a user when using the digital camera, and FIG. 1B is a top view.

In FIGS. 1A and 1B, the digital camera 1 has a panoramic shooting mode. A shutter button 2 is an operation unit for issuing a shooting instruction to the digital camera 1. A zoom operation member 3 is an operation member for adjusting an angle of view, where a user can adjust the angle of view by putting his/her finger on a lever 3a, and turning the lever left or right. In this process, control is performed such that the angle of view is adjusted to a wide-angle side when the zoom operation member 3 is turned counterclockwise, and to a telephoto side when the zoom operation member 3 is turned clockwise. The zoom operation member 3 is not limited to being moved via the use of a lever. In another embodiment, a button for adjusting the angle of view to the wide-angle side and a button for adjusting the angle of view to the telephoto side is provided.

A power switch 4 is a switch for turning a power source of the digital camera 1 on and off. A mode dial 5 is an operation unit for switching among various types of modes. A controller wheel 6 is an operation member capable of performing a rotating operation. In the digital camera 1, the surface on which the mode dial 5 and the controller wheel 6 are provided can include various other switches and buttons which receive various operations from the user. A display unit 7 is formed by a small-sized liquid crystal panel or the like, and displays images or various information associated with the status of the digital camera, etc.

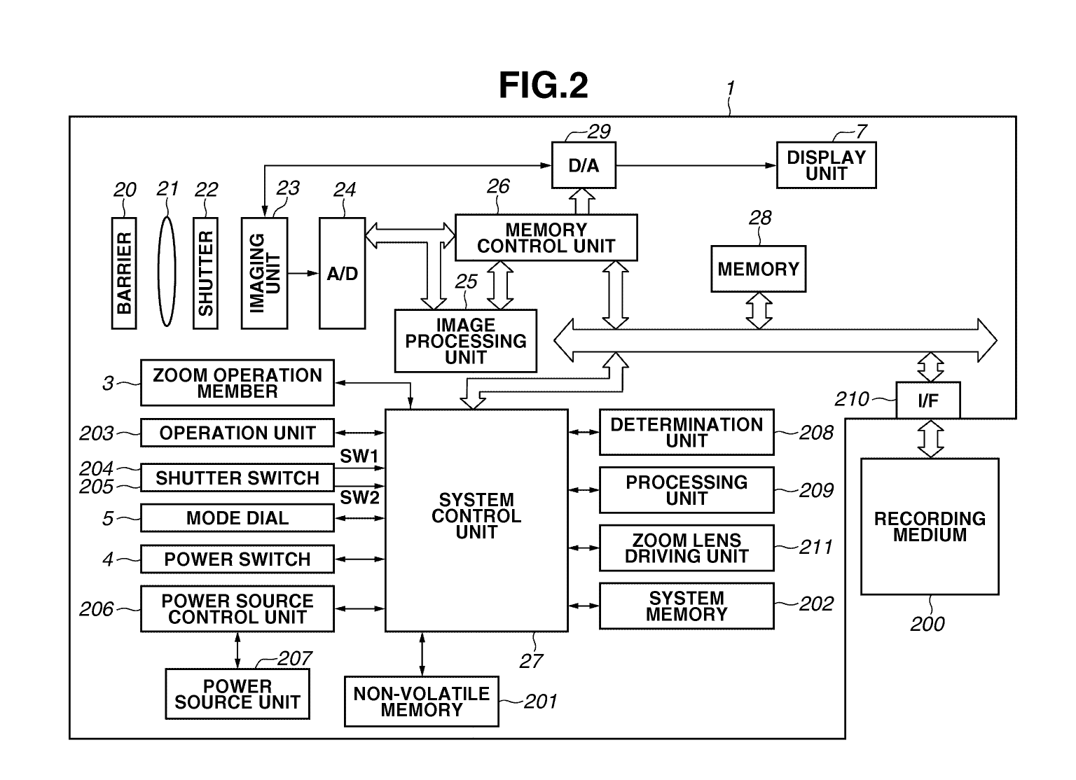

FIG. 2 is a block diagram illustrating an example of an internal configuration of the digital camera 1.

The digital camera 1 includes a barrier 20, which protects the digital camera's 1 optical system from dirt and damage by covering a shooting lens 21 or the like. The shooting lens 21 is a lens group including a focus lens or a zoom lens. A shutter 22 is a shutter having an aperture function.

An imaging unit 23 is formed by a charge-coupled device (CCD) or a complementary metal-oxide-semiconductor (CMOS) which converts an optical image into an electric signal. An analog-to-digital (A/D) converter 24 converts an analog signal into a digital signal. More specifically, the A/D converter 24 converts an analog signal output from the imaging unit 23 into a digital signal.

An image processing unit 25 performs predetermined pixel interpolation, resize processing such as reduction, and color conversion processing on data from the A/D converter 24, or data from a memory control unit 26. Further, in the image processing unit 25, predetermined arithmetic processing is executed using data of a captured image. A system control unit 27 performs exposure control and range-finding control based on an arithmetic result obtained by the image processing unit 25. Accordingly, auto-focus (AF) processing of a through-the-lens (TTL) method, automatic exposure (AE) processing, and flash pre-emission (EF) processing are performed. The image processing unit 25 further performs predetermined arithmetic processing using the captured image data and performs auto-white balance (AWB) processing of the TTL method based on the obtained arithmetic result.

Output data from the A/D converter 24 is directly written into a memory 28 via the image processing unit 25 and the memory control unit 26, or via the memory control unit 26. The memory 28 stores the image data converted into digital data by the A/D converter 24, and the image data to be displayed on the display unit 7. The memory 28 has a sufficient storage capacity to store a predetermined number of still images, and moving images and sound for a predetermined length of time. Further, the memory 28 serves as a memory (video memory) for an image display.

A digital-to-analog (D/A) converter 29 converts the data for the image display stored in the memory 28 into an analog signal and supplies the analog signal to the display unit 7. In this manner, the image data for display written in the memory 28 is displayed by the display unit 7 via the D/A converter 29. The display unit 7 performs a display corresponding to the analog signal from the D/A converter 29 on a display device such as a liquid crystal display (LCD).

The system control unit 27 controls the entire digital camera 1. More specifically, the system control unit 27 implements various types of processing described below by executing the programs stored in a nonvolatile memory 201. Further, the system control unit 27 also performs display control by performing controls of the memory 28, the D/A converter 29, the display unit 7, and the like.

The nonvolatile memory 201 is an electrically erasable/recordable memory, and includes, for example, an electronically erasable programmable read-only memory (EEPROM) and the like. In the nonvolatile memory 201, constants and programs for an operation of the system control unit 27 are stored. The programs herein are programs for executing various types of processing described below.

A system memory 202 may include a random-access memory (RAM). In the system memory 202, constants and variables for operations of the system control unit 27, and the programs read out from the nonvolatile memory 201 are developed.

An operation unit 203, a first shutter switch 204, a second shutter switch 205, and a mode dial 5 are operating units for inputting various operation instructions to the system control unit 27.

Each operation member included in the operation unit 203 is assigned an appropriate function according to each scene by selecting and operating various function icons displayed on the display unit 7, and serves as various function buttons. The function buttons may include, for example, a menu button, an end button, a return button, an image advancing button, a jump button, an aperture reducing button, and an attribute change button. When the menu button is pressed, a menu screen that enables a user to perform various settings is displayed on the display unit 7. The user can intuitively perform various settings using the menu screen displayed on the display unit 7, the controller wheel 6, and the like.

The controller wheel 6 is a rotatable operation member included in the operation unit 203, and is used when a selection item is instructed, in conjunction with a direction button. When the controller wheel 6 is operated by rotating, an electric pulse signal is generated according to an operation amount. In response to the pulse signal, the system control unit 27 controls respective units of the digital camera 1. Further, the system control unit 27 can determine an angle at which the controller wheel 6 has been rotated or how many times it has rotated based on the pulse signal.

The controller wheel 6 may be any type of an operation member that can be used to detect a rotation operation. For example, a dial operation member maybe also used, in which the controller wheel 6 itself rotates to generate a pulse signal in accordance with a rotation operation by the user. Alternatively, the operation member maybe a touch sensor that detects a rotation operation of the user's finger on the controller wheel 6 (what is called a touch wheel), while the controller wheel 6 itself does not rotate.

The zoom operation member 3 is an operation member included in the operation unit 203 for adjusting an angle of view as desired by manipulating the lever to a wide-angle side or a telephoto side. When the zoom operation member 3 is operated, an electric pulse signal is generated according to an operation amount. Based on the pulse signal, the system control unit 27 can control the shooting lens 21 to change the angle of view to a wide angle view or a telephoto view.

The first shutter switch 204 is turned on halfway through in an operation, what is called a half-pressed (shooting preparatory instruction), of a shutter button 2 provided in the digital camera 1 and generates a first shutter switch signal SW1. The system control unit 27 starts operations, such as auto-focus (AF) processing, automatic exposure (AE) processing, auto-white-balance (AWB) processing, and flash pre-emission (EF) processing, in response to an input of the first shutter switch signal SW1.

The second shutter switch 205 is turned on upon completion of the operation of the shutter button 2, what is called a full-pressed (shooting instruction), and generates a second shutter switch signal SW2. The system control unit 27 starts operations of a series of shooting processing from reading out signals from the imaging unit 23 to writing the image data into a recording medium 200, in response to an input of the second shutter switch signal SW2.

The mode dial 5 switches operation modes of the system control unit 27 to any one of a still image recording mode, a moving image recording mode, and a reproduction mode.

A power source control unit 206 includes a battery detection circuit, a direct current to direct current (DC-DC) converter, a switching circuit for switching blocks to be energized, and the like (which are not illustrated), and detects presence/absence of a loaded battery, a type of the battery, and a remaining battery capacity. Further, the power source control unit 206 controls the DC-DC converter based on the detection results and instructions from the system control unit 27, and supplies necessary voltages for a necessary period of time to respective units including the recording medium 200.

The power source unit 207 may includes a primary battery, such as an alkali battery and a lithium (Li) battery, a secondary battery, such as a nickel-cadmium (NiCd) battery, a nickel metal hydride (NiMH) battery, and Li battery, and an alternating current (AC) adapter.

A determination unit 208 determines whether a position of the shooting lens 21 adjusted by the zoom operation member 3 is at a wide-angle end. Instead of providing the determination unit 208 as independent hardware, the system control unit 27 may realize the functions similar to those of the determination unit 208.

A processing unit 209 performs processing for shifting the mode to the panoramic shooting mode for obtaining a panoramic image by combining a plurality of images, when the zoom operation member 3 is operated to the wide-angle side, and it is determined as the wide-angle end by the determination unit 208. Instead of providing the processing unit 209 as independent hardware, the system control unit 27 may realize the functions similar to those of the processing unit 209.

An interface (I/F) 210 is an interface with the recording medium. 200 such as a memory card or a hard disk. The recording medium 200 is a recording medium such as a memory card, and may include a semiconductor memory, a magnetic disk, and so forth.

A zoom lens driving unit 211 is a driving unit for driving a zoom lens of the shooting lens 21.

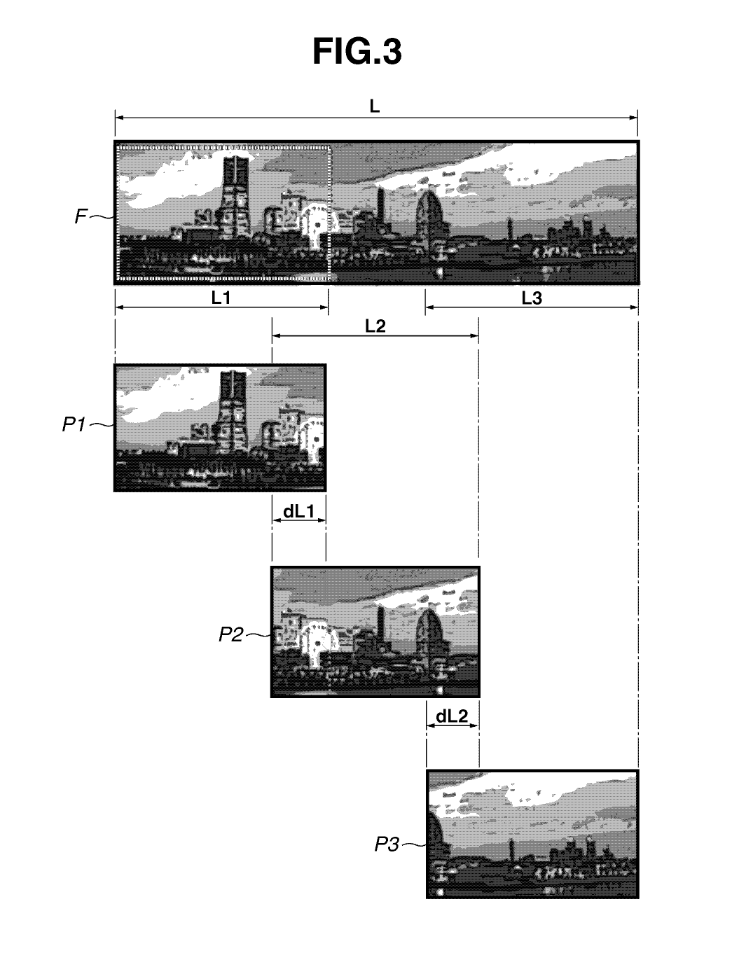

Next, a panoramic shooting function in the digital camera 1 will be described with reference to FIG. 3.

FIG. 3 illustrates the widest angle of view (shooting range) which the digital camera 1 in FIGS. 1A and 1B can shoot in one shooting operation.

A range L includes a landscape that the user targets for shooting. A rectangle F indicated with a dotted line in FIG. 3 represents the widest angle of view that the digital camera 1 can shoot in one shooting operation. In shooting of the range L, the user operates the zoom operation member 3 to the wide-angle side, and adjusts the angle of view so that a wider-angle shooting can be performed.

However, since the range L is broader than a long side of the rectangle F, the range L extends far beyond the long side of the rectangle F, and the zoom operation member 3 reaches the wide-angle end. When the zoom operation member 3 is further operated to the wide-angle side from this status, the digital camera 1 shifts to the panoramic shooting mode.

In the panoramic shooting mode in the digital camera 1, an operation screen for performing a plurality of times of shooting operations is displayed on the display unit 7, and a plurality of times of shooting is performed according to an instruction from the user to perform a plurality of times of shooting. A plurality of images obtained by the panoramic shooting mode is recorded by being associated with each other in such a manner that a positional relationship in which they are mutually combined can be found. The plurality of recorded images can be combined by a known combining method, and one panoramic image is created.

A specific shooting method for the panoramic shooting mode will be described.

First of all, the user holds the digital camera 1 still to cover an area of a left-side of the range L, and shoots an image of a shooting range L1. The image obtained in the process is referred to as an image P1.

Next, the user shoots an image of a shooting range L2 to provide an area that overlaps with the shooting range L1 by a length dL1. The image obtained in the process is referred to as an image P2. The digital camera 1 transparently displays an overlapping right-side of the image of the shooting range L1 on a left-side region of a through-image, so that it makes easier for the user to find positioning of the shooting range L2.

Next, the user shoots an image of a shooting range L3 to provide an area that overlaps with the shooting range L2 by a length dL2. The image obtained in the process is referred to as an image P3.

The images P1 to P3 are recorded on the recording medium 200 by being associated with each other so that the user can find out the positional relationship in which they are combined. The images P1 to P3 can be combined by the known combining method, and thus one panoramic image can be obtained.

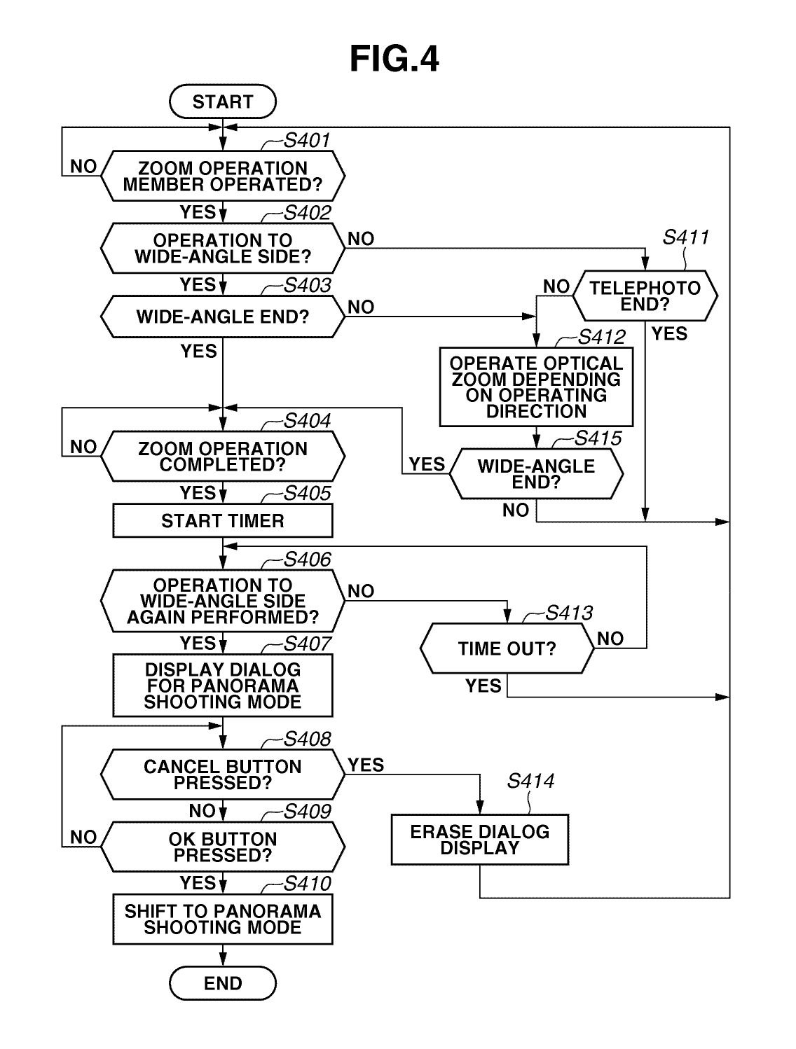

FIG. 4 is a flowchart illustrating a flow of the panoramic shooting mode shifting process in the first exemplary embodiment. Each processing in the present flowchart is realized by the system control unit 27 developing and executing a program stored in the nonvolatile memory 201 in the system memory 202.

First, in step S401, the system control unit 27 determines whether the zoom operation member 3 is operated by the user. If it is determined that the zoom operation member 3 is operated (YES in step S401), then in step S402, the system control unit 27 determines whether the zoom operation member 3 is operated to the wide-angle side.

If it is determined that the operation is not to the wide-angle side (NO in step S402), then the processing proceeds to step S411. On the other hand, if it is determined that the operation is to the wide-angle side (YES in step S402), then in step S403, the system control unit 27 causes the determination unit 208 to determine whether a current lens position is at the wide-angle end.

If it is determined that the current lens position is not at the wide-angle end (NO in step S403), then the processing proceeds to step S412. On the other hand, if it is determined that the current lens position is at the wide-angle end (YES in step S403), then in step S404, the system control unit 27 determines whether the zoom operation is completed.

If it is determined that the zoom operation is completed (YES in step S404), then in step S405, the system control unit 27 activates a timer, and measures a length of time since the zoom operation member 3 is operated. In step S405, the system control unit 27 functions as a time measuring unit.

In step S406, the system control unit 27 again determines whether the zoom operation member 3 is operated to the wide-angle side after the timer start.

If it is determined again that the zoom operation member 3 is not operated to the wide-angle side (NO in step S406), then in step S413, the system control unit 27 determines whether a fixed length of time has elapsed (time-out). If it is determined that the timer is not timed out (NO in step S413), then the processing returns to step S406.

The fixed length of time has only to be the same order of length of time taken for the user to determine an angle of view, and the user can arbitrarily set it. If it is determined that the timer is timed out (YES in step S413), then the processing returns to step S401.

In the present exemplary embodiment, if the operation of the zoom operation member 3 for zooming to the wide-angle side has continued for a predetermined length of time or longer, the system control unit 27 performs control to execute the panoramic shooting mode shifting process.

If it is determined again that the zoom operation member 3 is operated to the wide-angle side (YES in step S406), then in step S407, the system control unit 27 displays on the display unit 7 a dialog for receiving from the user a selection whether to shift to the panoramic shooting mode, as illustrated in FIG. 1A.

Here, a step for the user to select whether to shift to the panoramic shooting mode is provided, instead of immediately shifting to the panoramic shooting mode, so that unintentionally shifting to the panoramic shooting mode due to an operational mistake can be prevented.

Next, in step S408, the system control unit 27 determines whether a cancel button is pressed by the user while the dialog is displayed on the display unit 7. If it is determined that the cancel button is pressed by the user (YES in step S408), then in step S414, the system control unit 27 erases the dialog display and returns the processing to step S401.

Next, in step S409, the system control unit 27 determines whether an OK button is pressed by the user. If it is determined that the OK button is pressed by the user (YES in step S409), then in step S410, the system control unit 27 controls the processing unit 209 to shift to the panoramic shooting mode.

In step S411, the system control unit 27 determines whether the current lens position is at the telephoto end. If it is determined that the current lens position is at the telephoto end (YES in step S411), then the processing returns to step S401. The image may be enlarged by operating an electronic zoom. If it is determined that the current lens position is not at the telephoto end (NO in step S411), then the processing proceeds to step S412.

In step S412, the system control unit 27 operates an optical zoom according to an operation direction of the zoom operation member 3, and the processing proceeds to step S415.

In step S415, the system control unit 27 causes the determination unit 208 to determine whether the lens has reached the position of the wide-angle end by the operation of the optical zoom in step S412. If it is determined that the lens has reached the position of the wide-angle end (YES in step S415), then the processing proceeds to step S404. If it is determined that the lens has not reached the position of the wide-angle end (NO in step S415), then the processing returns to step S401.

In the present exemplary embodiment, an example of shooting from left to right is described as the panoramic shooting mode. However, it is also possible to change to the opposite direction (from right to left), up and down directions, or up and down or left and right directions. Accordingly, various panoramic images can be generated according to the user's intention.

In addition, instead of shooting a plurality of images one by one, it is possible to change the shooting operation such that continuous shooting is automatically performed, and images in an area which exceeds an angle of view are combined, as discussed in Japanese Patent Application Laid-Open No. 2009-182536. Since the shooting operations can be performed continuously, there is no need to press the shutter button several times while changing the angles of view, and necessary images can be acquired only by pointing the imaging apparatus in a direction from which the user wants to obtain a panoramic image after pressing the shutter button at the beginning.

Moreover, in the present exemplary embodiment, an example is described, in which the fact that the zoom operation member is operated again to the wide-angle side within the predetermined length time since the zoom operation member is operated to the wide-angle end is taken as a trigger for shifting to the panoramic shooting mode. In addition to this, the fact that an operation of the zoom operation member to the wide-angle side has been continued for the predetermined length of time or longer since the zoom operation member is operated to the wide-angle end may be taken as a trigger.

Further, without performing time measurement by the timer starting from step S405 and regardless of an elapsed time length from completion of the preceding operation, the fact that the zoom operation member is operated to the wide-angle side when the current zoom position is at the wide-angle end may be simply taken as a trigger for shifting to the panoramic shooting mode.

As described above, the digital camera 1 can shift to the panoramic shooting mode based on an operation to determine an angle of view by the user. The user can shift the process, by the zoom operation performed when determining an angle of view, to the panoramic shooting mode which is a function concerning adjustment of the angle of view. Accordingly, the user can shift the process to the panoramic shooting mode, without performing a complicated operation. According to the exemplary embodiment, a user who does not know a shifting method to the panoramic shooting mode can be given an opportunity to use the panoramic shooting mode.

A second exemplary embodiment of the present invention includes configurations illustrated in FIGS. 1A and 1B and FIG. 2 similar to those in the above-described first exemplary embodiment. The same reference numerals are used for components and units similar to those in the first exemplary embodiment, and descriptions thereof will not be repeated. Only points that are different from the above-described first exemplary embodiment will be described below.

In the second exemplary embodiment, a flow of the panoramic shooting processing when a moving object is included in a composition during the panoramic shooting operation will be described.

When performing the panoramic shooting by the digital camera 1, a user performs shooting two or more times with varying orientations of the camera, while providing a fixed overlapping area so that a desired range can be captured. In this process, in a case where a moving object is present in the composition, and the moving object is captured in the overlapping area of one image and is not captured in the overlapping area of the other image in consecutive two images, there may occur a defect in connection of images since the images in the overlapping area do not coincide with each other.

Further, in a case where the moving object is present in the composition, and the moving object is captured in non-overlapping areas of both the consecutive two images, connection of these two images can be performed well since the images in the overlapping area coincide with each other. However, an unnatural panoramic image that includes the same object in two locations will be generated. So, the digital camera according to the present invention is characterized in that, when the camera recognizes a moving object, a control for shifting to the panoramic shooting mode as described in the first exemplary embodiment is not performed.

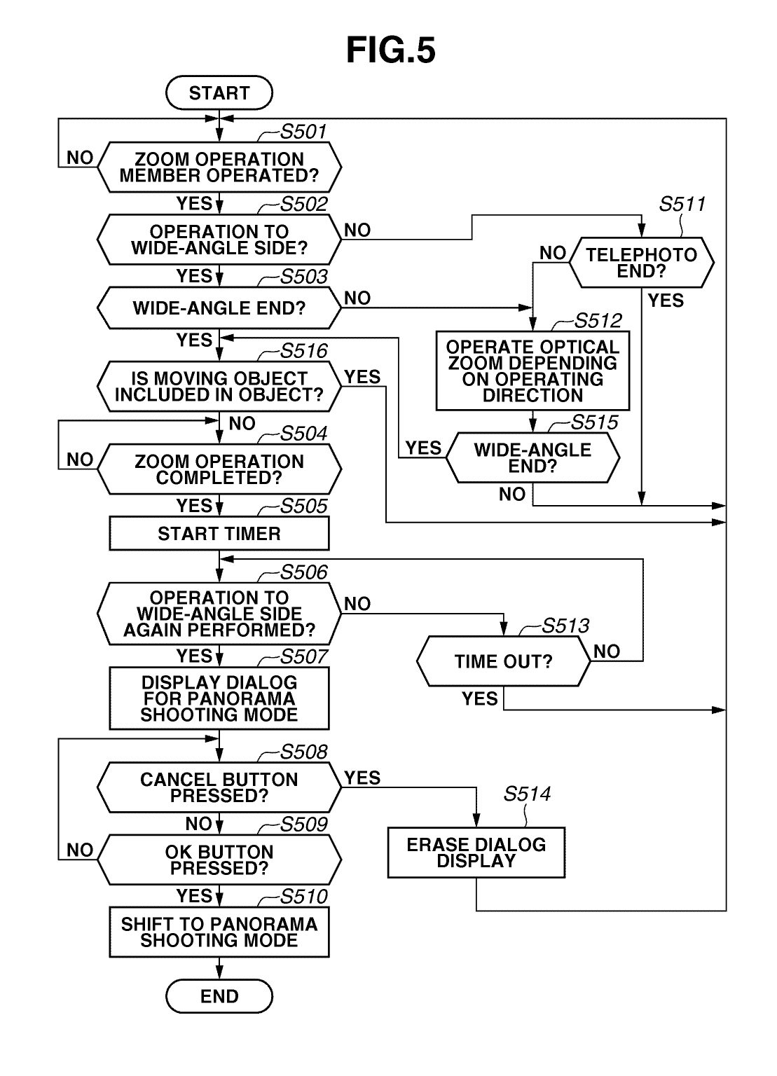

FIG. 5 is a flowchart illustrating a flow of the panoramic shooting mode shifting process in the second exemplary embodiment. Each processing in the present flowchart is realized by the system control unit 27 developing and executing a program stored in the nonvolatile memory 201 in the system memory 202. Step S501 to step S515 in FIG. 5 correspond to step S401 to step S415 in FIG. 4, and thus descriptions thereof will not be repeated.

In FIG. 5, in step S503, if it is determined that current lens position is at the wide-angle end (YES in step S503), then in step S516, the system control unit 27 determines whether a moving object is included in an object in the composition. In step S516, the system control unit 27 functions as a moving object determination unit.

A technique for recognizing a moving object included in the composition is a well-known technique for persons skilled in the art in technical fields relating to the imaging apparatuses as discussed in, for example, Japanese Patent Application Laid-Open No. 05-80248 and Japanese Patent Application Laid-Open No. 06-169458. Thus, the present exemplary embodiment adopts the similar technique for realizing the moving object recognition.

If it is determined that the moving object is included in the composition (YES in step S516), then the processing returns to step S501. On the other hand, if it is determined that the moving object is not included in the composition (NO in step S516), then the processing from step S504 onward are executed.

As described above, in the digital camera according to the present exemplary embodiment, if the moving object is not included in the composition, the shooting mode is shifted to the panoramic shooting mode based on an operation by the user to determine an angle of view. On the other hand, if the moving object is included in the composition, the shooting mode is controlled so as not to shift to the panoramic shooting mode based on the operation by the user. Accordingly, if the moving object is included in the composition, the shooting mode is not shifted to the panoramic shooting mode, and as a result, the effect of preventing generation of defective images can be produced.

When the shutter button 2 is pressed while the processing in FIG. 4 and FIG. 5 is currently executed, priority is placed on the processing relating to the imaging.

Control of the system control unit 27 may be performed by one hardware device, or control of the entire apparatus may be performed by sharing the processing by a plurality of hardware devices.

Aspects of the present invention can also be realized by a computer of a system or apparatus (or devices such as a central processing unit (CPU) or a micro processing unit (MPU)) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment (s). For this purpose, the program is provided to the computer for example via a network or from a recording medium of various types serving as the memory device (e.g., computer-readable medium). In this case, the program and the storage media storing the program constitutes the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-173625 filed Aug. 2, 2010, which is hereby incorporated by reference herein in its entirety.

What is claimed is:

1. An imaging apparatus comprising:
an imaging unit;
a zoom operation member;
a driving unit configured to drive a zoom lens according to an operation to the zoom operation member; and
a processing unit configured to execute control to perform processing for shifting to a panoramic shooting mode for shooting a plurality of images to be combined as a panoramic image if the zoom lens is positioned at a wide-angle end and the zoom operation member is further operated to zoom to a wide-angle side.

2. The imaging apparatus according to claim 1, wherein the processing unit further performs processing for providing a display for receiving from a user a selection whether to shift to the panoramic shooting mode.

3. The imaging apparatus according to claim 2, wherein if shifting to the panoramic shooting mode is selected, shifting to the panoramic shooting mode is executed.

4. The imaging apparatus according to claim 1, wherein the processing unit further performs processing for shifting to the panoramic shooting mode.

5. The imaging apparatus according to claim 1, further comprising:
a time measuring unit configured to measure a length of time since an operation to the zoom operation member is completed in a case where the zoom lens is positioned at the wide-angle end,
wherein, if the zoom lens is positioned at the wide-angle end and the zoom operation member is operated to zoom to the wide-angle side, and if time measured by the time measuring unit is within a predetermined length of time, the processing unit executes control to perform processing for shifting to the panoramic shooting mode.

6. The imaging apparatus according to claim 1, wherein, if the zoom lens is positioned at the wide-angle end and the operation to the zoom operation member to zoom to the wide-angle side is continued for a predetermined length of time or longer, the processing unit executes control to perform processing for shifting to the panoramic shooting mode.

7. The imaging apparatus according to claim 1, further comprising:
a moving object determination unit configured to determine whether a moving object is included in an image captured by the imaging unit,
wherein if it is determined that a moving object is included in the image, the processing unit does not execute control for shifting to the panoramic shooting mode regardless of an operation to the zoom operation member.

8. A method for controlling an imaging apparatus including an imaging unit, a zoom operation member, and a driving unit configured to drive a zoom lens according to an operation to the zoom operation member, the method comprising:
executing control to perform processing for shifting to a panoramic shooting mode for shooting a plurality of images to be combined as a panoramic image, if the zoom lens is positioned at a wide-angle end and the zoom operation member is further operated to zoom to a wide-angle side.

9. A computer-readable non-transitory storage medium which stores a computer-readable program for causing an imaging apparatus to perform the method of claim 8.
